(19) United States
(12) Patent Application Publication
(10) Pub. No.: US 2014/0273986 A1
(43) Pub. Date: Sep. 18, 2014

(54) SERVICE AWARE SOFTWARE ARCHITECTURE IN WIRELESS DEVICE ECOSYSTEM

(71) Applicants: Michael Edward Smith Luna, San Jose, CA (US); Thomas Alan Donaldson, London (GB)

(72) Inventors: Michael Edward Smith Luna, San Jose, CA (US); Thomas Alan Donaldson, London (GB)

(73) Assignee: AliphCom, San Francisco, CA (US)

(21) Appl. No.: 13/802,425

(22) Filed: Mar. 13, 2013

(51) Int. Cl. H04W 4/00

(52) U.S. Cl. CPC H04W 4/001
USPC 455/414.1

(57) ABSTRACT

Techniques associated with service aware software architecture in a wireless device ecosystem are described, including generating, by an application, an intended event, discovering, using an operating system comprising a service discovery module, one or more available services on a device in data communication, with the application, and selecting, using the operating system, a preferred service configured to provide an output associated with the intended event.

### FIELD OF THE INVENTION

The invention relates generally to electrical and electronic hardware, computer software, wired and wireless network communications, and computing devices. More specifically, techniques associated with service aware software architecture in wireless device ecosystem are described.

### BACKGROUND OF THE INVENTION

Wireless devices are used to store, analyze, and provide data associated with every aspect of a user's life. Users typically surround themselves with a plethora of wireless devices, each having different capabilities and services. Conventional wireless devices, however, typically do not include software architecture designed to automatically discover and select an optimum or preferred device and service for providing a particular function or operation. Conventional wireless devices typically require user selections of devices and services for performing an operation, or providing a function. While conventional devices often have service discovery capabilities, such service discovery functions are often tied to a particular application or communication protocol, and such conventional devices typically do not leverage such capabilities to select a preferred device or service within an group (i.e., ecosystem) of wireless devices.

Thus, what is needed is a solution for service aware software architecture in a wireless device ecosystem without the limitations of conventional techniques.

### BRIEF DESCRIPTION OF THE DRAWINGS

Various embodiments of the invention are disclosed, in the following detailed description and the accompanying drawings:

FIG. 1 illustrates an exemplary architecture for a data capable wireless device in a wireless device ecosystem;

FIG. 2 illustrates a diagram depicting an exemplary system of components in a wireless device ecosystem, including a service aware operating system;

FIG. 3 illustrates a diagram depicting exemplary wireless devices capable of exchanging services data in a wireless device ecosystem;

FIG. 4 illustrates an exemplary wireless device ecosystem;

FIG. 5 illustrates an exemplary flow for rendering an intended event into a sensory output;

FIG. 6 illustrates an exemplary flow for selecting a preferred service for providing an output; and

FIG. 7 illustrates an exemplary computing platform disposed in or associated with a wireless device having service aware software architecture.

Although the above-described drawings, depict various examples of the invention, the invention is not limited by the depicted examples. It is to be understood that, in the drawings, like reference numerals designate like structural elements. Also, it is understood that the drawings are not necessarily to scale.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

In some examples, the described techniques may be implemented as a computer program or application (“application”) or as a plug-in, module, or sub-component of another application. The described techniques may be implemented as software, hardware, firmware, circuitry, or a combination thereof. If implemented as software, then the described techniques may be implemented using various types of programming, development, scripting, or formatting languages, frameworks, syntax, applications, protocols, objects, or techniques, including ASP, ASP.net, .Net framework. Ruby, Ruby on Rails, C, Objective C, C++, C#, Adobe® Integrated Runtime™ (Adobe® AIR™. ActionScript™, Flex™, Lingo™, Java™, Javascript™, Ajax, Perl, COBOL, Fortran, ADA, XML, MXML, HTML, DHTML, XHTML, HTTP, XMPP, PHP, and others. Software and/or firmware implementations may be embodied in a mm-transitory computer readable medium configured for execution by a general purpose computing system or the like. The described techniques may be varied and are not limited to the examples or descriptions provided.

FIG. 1 illustrates an exemplary architecture for a data capable wireless device in a wireless device ecosystem. Here, data capable wireless device (“wireless device”) 301 may include memory 102, sensor 104, application programming interface (API) 106, application 108, operating system 110, user interface 112, antenna 116, and communication facility 114, and may be configured to communicate or exchange data with output device 118 and/or a network. In some examples, operating system 110 may be configured to manage hardware and software resources of wireless device 101. In some examples, sensor 104 may include one or more sensors configured to capture data associated with a user's location, environment, movement, physiology and behavior-related traits (e.g., accelerometer, thermometer, altimeter/barometer, light/infrared (“IR”) sensor, pulse/heart rate (“HR”) monitor, audio sensor (e.g., microphone, transducer, or others), global positioning system (GPS) receiver, location-based service sensor (e.g., sensor for determining location within a cellular or micro-cellular network, which may or may not use GPS or other satellite constellations for fixing a position), motion detection sensor, environmental sensor, chemical sensor, other electrical sensor, other mechanical sensor, or the like). In some examples, sensor 104 may provide sensor data (e.g., environmental data, location data, user behavior data, and the like) to application 108, for example, using API 106, and application 10S may use said sensor data for event, processing or analysis, among other tasks. In other examples, sensor 104 may provide sensor data to operating system 110, and operating system 110 may use said sensor data for service selection or generating service profile data (e.g., by service selection module 206 and service profile module 208 in FIG. 2). In some examples, API 106 may include one or more protocols or specifications to enable communication between various software components, including operating system 110, application 108, and other components of wireless device 101.

in some examples, operating system 110 may be configured to provide management and other common services for one or more programs or applications implemented in wireless device 101. As used herein, “service” may refer to a function, or set of functions, that may be used for various purposes (e.g., audio output function, LED light function, other light output function, video output function, vibratory output function, radio signal transceiver function, short-range communication function, or the like). In some examples, operating system 110 may be configured to publish available services on wireless device 101, for example, services that may be provided using user interface 112 or other sensory output mechanism (e.g., vibratory, light, audio, video or the like). For example, operating system 110 may be configured to generate data (e.g. representing codes, descriptors, or the like, according to one or more data communication protocols) associated with available services on wireless device 101 to be communicated to other modules in wireless device 101 or other wireless devices using communication facility 114, for example, using a network, a short-range communication protocol (e.g., Bluetooth®, ultra wideband, NFC, or the like), or the like. In some examples, operating system 110 also may be configured to search for and identify (i.e., discover) available services on devices with which wireless device 101 may be in data communication (e.g., output device 118, other devices within a threshold proximity for short-range data communication, or the like). As used herein, a service may be “available” if it is functional on an accessible device (i.e., a device with which an operating system searching for or discovering services may exchange data) that is, or may be, turned on. In some examples, operating system 110 may be configured to compare one or more available services, on wireless device 101 output device 118 or other devices, and to process and consider sensor data (e.g., environmental data, location data, user behavior data, and the like), user preference data (e.g., as provided by user interface 112, stored in memory 102, stored in a remote storage (i.e., accessible using a network), or the like), pre-programmed service environment data, and other data, to select a preferred service for performing an operation (e.g., providing an output, or otherwise rendering an event to a physical manifestation). For example, if application 108 receives or generates data representing an intended event, such as an intention to perform an operation (e.g., provide a notification, broadcast a private message to a user, broadcast a public message to a group of users or all users in an area or environment, or the like), operating system 110 may be configured to discover available services, associated with wireless device 101 and any other device with which short-range data communication is possible, to obtain and process sensor and user preference data, and to select a preferred service, which is a service that is better or best suited to perform the operation, in view of a user's preferences, a user's environment, and the nature of the operation (e.g., public, private, alarm, message, notification achievable using light or vibration, notification associated with a graphic or text, and the like). In other examples, operating system 110 also may be configured to generate a virtual audiograph, configured to render an abstract audiograph to a hardware graph, for ease of switching elements or functionalities on and off in varying devices or hardware units without manually navigating a physical map of input/output (I/O) hardware sources to each software block or module. In other examples, operating system 110 may be implemented with additional functionalities.

In some examples, data capable wireless device 101 may be configured to be worn (i.e., wearable), or carried. In some examples, communication facility 114 may be configured to communicate with output device 118 automatically when, output device 118 is within a threshold proximity of data capable wireless device 101. As used herein, “facility” refers to any, some, or all of the features, and structures that are used to implement a given set of functions. An example of a communication facility is described in co-pending U.S. patent application Ser. No. ______, filed Mar. YY, 2013, entitled “Intelligent Device Connection for Wireless Media Ecosystem.” As used herein, “threshold proximity” may refer to an actual distance or may be based upon a signal strength, for example, of a mobile device (e.g., output device 118 or the like). In some examples, a threshold proximity may represent a maximum distance, or minimum signal strength, in which data capable wireless device 101 may exchange data with output device 118 using a short-range communication protocol. In some examples, a threshold proximity may be determined using proximity and location data obtained by antenna 116. In some examples, a threshold proximity may be predetermined and preprogrammed into data capable wireless device 101. In other examples, a threshold proximity may be determined dynamically using data obtained from antenna 116, sensor 104, user interface 112, and other sources in, or in data communication with, data capable wireless device 101.

In some examples, antenna 116 may be implemented as a receiver, transmitter, or transceiver, configured to detect and generate radio waves, for example, to and from electrical signals. In some examples, antenna 116 may be configured to detect radio signals across abroad spectrum, including licensed and unlicensed bands (e.g., WiFi, Bluetooth®, NFC, ultra wideband, or other bands). In some examples, antenna 116 may be configured to generate data associated with a radio signal or energy from output device 118, or other wireless devices, including proximity data (i.e., data associated with a proximity of a wireless device) and location data (i.e., data associated with a location (e.g., direction, position, either in a room or other environment, and the like) of a wireless device). In other examples, the quantity, type, function, structure, and configuration of the elements shown may be varied and are not limited to the examples provided.

FIG. 2 illustrates a diagram depicting an exemplary system of components in a wireless device ecosystem. Here, diagram 200 includes operating system 201, having service publishing module 202, service discovery module 204, service selection module 206, service profile module 208, and data interface 210, as well as application 211, having event processing module 212 and communication module 214, as well as storage 216. Like-numbered and named elements may describe the same or substantially similar elements as those shown in other descriptions, in some examples, storage 216 may be configured to store service environment data 218, service profile data 220, as well as other data. In other examples, storage 216 may be configured, to store other data, including user preference data (i.e., in user profiles), environmental data (i.e., captured by sensors), or the like. In some examples, storage 216 may be implemented in a device with operating system 201 and application 211. In other examples, storage 216 may be implemented remotely, and accessible by operating system 201 and application 211 using a network, in some examples, service environment data 218 may include predetermined or preprogrammed service data associated with a device (e.g., a type of mobile device (e.g., a smartphone, a tablet, a laptop, another mobile communication device, another mobile computing device, an output device, or the like), a category of devices (e.g., audio devices, video devices, vibratory devices, display devices, and the like), or the like) or a known device ecosystem (e.g., a room in a house or office, a suite or group of mobile devices associated with (i.e., carried by) a user, a suite or group of mobile devices associated with (i.e., carried by) a team or group of users, or the like). For example, service environment data 218 may include data representing standard, enhanced, and/or all services available on a category of audio devices (e.g., headphones, headsets, speakers, speaker systems, or the like), in another example, service environment data 218 may include data representing some or all services available on a suite of devices typically carried by a user (e.g., a smartphone, a Bluetooth® headset, a tablet computer, and the like). In some examples, service environment data 218 may be used by service selection module 206 for selecting a preferred service for performing an operation. In some examples, service profile data 220 may include data generated by service profile module 208 associated with characteristics of a service, including, without limitation, types of output that may be provided by a service, environments in which a service may effectively perform an operation (e.g., a visual display service may effectively convey a message including a graphic or text, an audio playback service may effectively play an audio message, an audio output service may effectively convey an alarm, a vibratory or vibration, service may effectively convey a non-audio, non-visual notification, and the like), environments in which a service is ill-suited or ineffective to perform an operation, (e.g., an audio output service may be ill-suited or ineffective for providing a notification, in an environment with high volume ambient noise, a light output service (e.g., LED display or the like) may be ill-suited or ineffective for providing a visual notification or message in an environment with bright, pulsating, or variant ambient lighting, and the like), types of events for which a service may be preferred, and the like. In some examples, data interface 210 may be configured to receive and send data associated with functions provided by operating system 201 (e.g., service publishing, service discovery, service selection, service profile generation, and the like). For example, data interlace 210 may be configured to receive sensor data 222 (e.g., from sensor 104 and/or memory 102 in FIG. 1, or the like) and user preference data 224 (e.g., from user interface 112 and/or memory 102 in FIG. 1, or the like). In another example, data interface 210 may be configured to exchange data (e.g., service environment data 218, service profile data 220, and the like) with storage 216. In still another example, data interface 210 may be configured to exchange data associated with an intended event or an available service with application 211. In some examples, application 211 may be configured to generate, or receive from another application, data associated with an intended event (e.g., an upcoming or recurring calendar entry, a pre-set alarm, a message (e.g., from a health and wellness application, a coaching application, a game, a friend, a family member, a team member, or the like), an incoming push notification, or the like), for example, using event processing module 212. In some examples, event processing module 212 may be configured to generate data representing one or more outputs associated with an intended event, for example, rendering said intended event into a sensory output. As used herein, a “sensory output” may refer to a physical manifestation able to be sensed by a user (e.g., an output suitable for providing a calendar notification, an output suitable for providing a message, an output suitable for providing an alarm, an output suitable for providing a push notification, or the like). In some examples, event processing module 212 may provide data associated with an intended event and associated outputs to service selection module 206, and service selection module 206 may select a preferred service using data from service publishing module 202, service discovery module 204 and service profile module 208, among other data (see, e.g., FIGS. 5-6 for processes associated with selecting a preferred service). In other examples, event processing module 212 may provide data associated with an intended event to service selection module 206, and service selection module 206 may be configured to determine one or more outputs suitable for rendering an intended event into a physical or sensory manifestation able to be sensed by a user (i.e., sensory output), as well as select a preferred service. In still other examples, event processing module 212, or another module in application 211 (not shown), may be configured to determine a preferred output or type of output for rendering an intended event into a sensory output, providing data associated with said preferred output or type of output to service selection module 206, and service selection module 206 may, in turn, select a preferred service capable of providing said preferred output or type of output.

In some examples, service discovery module 204 may be configured to search for and identify available services, both locally and on nearby devices (i.e., devices within a threshold proximity for short-range data communication). In some examples, service discovery module 204 may implement one or more service discovery protocols (e.g., Bluetooth® Service Discovery Protocol (Bluetooth® SDP), WiFi DNS Service Discovery (WiFi DNS-SD), multicast DNS-SD, or the like). In some examples, service publishing module 202 may be configured to publish (i.e., provide data associated with) services available on a local device (i.e., a device in which operating system 201 may be implemented, for example, wireless device 101 in FIG. 1, or the like), both to service discovery module 204, as well as to other devices in data communication with said local device, hi some examples, service discovery module 204 may provide data representing available services to service selection module 206, for selecting a preferred service. In some examples, service selection module 206 also may be configured to obtain or receive service profile data from service profile module 208 or storage 216, sensor data 222 and user preference data 224 using data interface 210, service environment data 218 from storage 216, and/or event data from application 211, to use in selecting a preferred service for performing an operating (e.g., providing an output, or the like) associated with an intended event. In other examples, the quantity, type, function, structure, and configuration of the elements shown may be varied and are not limited to the examples provided.

FIG. 3 illustrates a diagram depicting exemplary wireless devices capable of exchanging services data in a wireless device ecosystem. Here, diagram 300 includes data capable band (“band”) 302, mobile device 304, display 306 and speaker 308. In some examples, band 302 may include operating system 302a, user interface 302b, communication facility 302c and output device 302d. In some examples, mobile device 304 may include operating system 304a, user interface 304b, communication facility 304c and output device 304d. In some examples, display 306 may include operating system 306a, user interface 306b, communication facility 306c and output device 306d. In some examples, speaker 308 may include operating system 308a, user interface 308b, communication facility 308c and output device 308d. Like-numbered and named elements may describe the same or substantially similar elements as those shown in other descriptions. In some examples, operating systems 302a, 304a, 306a and 308a may include the service discovery and preferred service selection functionalities described herein (e.g., with respect to operating system 110 in FIG. 1, operating system 201 in FIG. 2, or the like), among other resource, software and hardware management functionalities. In some examples, communication facilities 302c, 304c, 306c and 308d may be configured to exchange data with each other, or with other devices (e.g., short-range communication controllers, networks, or the like) using short-range communication protocols (e.g., Bluetooth®, ultra wideband. NFC, or the like) or longer-range communication protocols (e.g., satellite, mobile broadband, GPS, WiFi, and the like).

In some examples, band 302 may be wearable, or configured to be carried. In some examples, band 302 may be implemented as a data-capable strapband, as described in co-pending U.S. patent application Ser. No. 13/158,372, co-pending U.S. patent application Ser. No. 13/180,320, co-pending U.S. patent application Ser. No. 13/492,857, and, co-pending U.S. patent application Ser. No. 13/181,495. In some examples, user interface 302b may include, without limitation, an LED light, display, a vibration source, one or more physical buttons, or the like. In some examples, mobile device 304 may be implemented as a smartphone, a tablet, laptop, or other mobile communication or mobile computing device. In some examples, user interface 304b may include, without limitation, a touchscreen, a display, one or more buttons, or the like. In some examples, display 306 may be implemented as a device having video output capabilities, as well as other input and output capabilities. For example, display 306 may include a speaker for audio output functions. In another example, display 306 may include a microphone, for audio or vibrational input functions. In some examples, display 306 may be implemented with user interface 306b, which may include, without limitation, a touchscreen display, one or more buttons, an LED light display, infrared transceiver or other wireless controller for receiving remote control signals, or the like. In some examples, speaker 308 may be implemented as a device having audio output capabilities, as well as other input and output capabilities. For example, speaker 308 may include a microphone for sensing or receiving audio or vibrational input. In another example, speaker 308 may include a set or suite of speakers, including different kinds of speakers (e.g., loudspeaker, subwoofer, and the like). In some examples, speaker 308 may be implemented with user interface 308b, which may include, without limitation, one or more buttons, an LED light display, a touchscreen, infrared transceiver or other wireless controller for receiving remote control signals, or the like.

to some examples, wireless device 304 may be configured to generate or receive data associated with an intended event (e.g., an incoming text message, an incoming voice message, an alarm, a calendar notification, or the like), for example, using one or more applications (not shown) installed on mobile device 304. In some examples, operating system 304a may be configured to discover one or more available services on mobile device 304 suitable for providing an output associated with the intended event. For example, operating system 304a may be configured to determine on or more outputs (e.g., a light, a light pattern, a text display, a graphic display, a sound, a vibration, a series of sounds, a series of vibrations, an audio output, a video output, or the like) associated with said intended event. In some examples, operating system 304a may exchange data with band 304, display 306 and/or speaker 308 to discover services available on band 304, display 306 and/or speaker 308, for example, using communication facility 304c. In some examples, said data, may be associated with an intended event, and operating systems 302a, 306a and 308a may be configured to determine one or more outputs associated with said intended event, to select available services for providing said one or more outputs, and to send data back to operating system 304a indicating available services suitable for providing said one or more outputs. In other examples, said data may be associated with one or more outputs determined by operating system 304a or an application (not shown) implemented on wireless device 304, and operating systems 302a, 306a and 308a may be configured to send data back to operating system 304a indicating one or more available services configured to provide said one or more outputs. In some examples, operating system 304a may be configured to select a preferred service by comparing and cross-referencing available services data from band 304, wearable device 304, display 306 and speaker 308, with sensor data, user preference data, and the like (see, e.g., flows 500 and 600 in FIGS. 5-6). For example, operating system 304a may choose band 302 to provide a vibratory notification in order to prompt a user to increase activity at a particular time, or after a particular time period, as determined by a health and wellness application (not shown) implemented on mobile device 304. In another example, operating system 304a may choose to show an incoming text message in a corner, quadrant, or other visible and unintrusive portion of display 306 while a user is viewing a video on display 306, as well as to light up a screen implemented on mobile device 304 (i.e., user interface 304b), and show said incoming text message on said screen. In some examples, data associated with other intended events may be generated or received by baud 302, display 306, and speaker 308, and operating systems 302a, 306a and 308a may be configured to perform the same service discovery and selection functions and described herein. In other examples, the quantity, type, function, structure, and configuration of the elements shown may be varied and are not limited to the examples provided.

FIG. 4 illustrates an exemplary wireless device ecosystem. Here, room 401 includes users 402-0-402-3, hands 404-0-404-3, wireless device 406, headset 408, display 410 and speaker 412. In some examples, band 404-0 may include operating system 404a, sensor 404b, API 404c, application 404d, memory 404e and user interface 404f. In some examples, bands 404-1-404-3 may be implemented with similar components and functionalities as band 404-0. In some examples, mobile device 406 may include operating system 406a and user interface 406b. In some examples, headset 408 may include operating system 408a and audio device 408b. In some examples, display 410 may include operating system 410a. In some examples, speaker 412 may include operating system 412a. Each of these devices may include a communication facility (not shown) configured to exchange data with other devices, as described herein (e.g., communication facility 114 in FIG. 1, communication facilities 302c, 304c, 306c and 308c in FIG. 3, and the like). Like-numbered and named elements may describe the same or substantially similar elements as those shown in other descriptions. In some examples, application 404d may receive or generate an intended event, providing data associated with said intended event to operating system 404a. In some examples, application 404d may determine one or more outputs associated with said intended event. In other examples, operating system 404a may determine one or more outputs associated with said intended event. In some examples, operating system 404a may send data to operating systems 406a, 408a, 410a and 412a to discover available services on mobile device 406, headset 408, display 410 and speaker 412, respectively. For example, operating system 404a may send a general query for all available services, or available services of a type, to operating systems 406a, 408a, 410a and 412a. In this example, operating system 404a may receive, in return, data associated with all, or a type of, available services in a wireless device ecosystem in room 403, and may compare said available services, including services available on bands 404-0-404-3, with one or more outputs determined to be associated with an intended event. In another example, operating system 404a may send data associated with an intended event to operating systems 406a, 408a, 410a and 412a, and operating systems 406a, 408a, 410a and 412a, in turn, may determine one or more outputs associated with said intended event to provide to operating system 404a data representing services configured to provide said one or more outputs.

In some examples, operating system 404a may obtain environmental, user behavior, motion, or other data from sensor 404b, user preference data from user interface 404f and/or memory 404e, and cross-reference such data with available services data from bands 404-0-404-3, mobile device 406, headset 408, display 410, speaker 412, to select a preferred service for providing an output associated with an intended event. For example, an intended event may be associated with a personal notification, and operating system 404a may select a vibration service associated with user interface 404f to provide a vibratory notification. In another example, an intended event may be associated with an incoming personal text, and operating system 404a may select a display service associated with user interface 406b as a preferred service to display said incoming personal text. In still another example, an intended event may be associated with an incoming voice message, and operating system 404a may select an audio output service associated with audio device 408b as a preferred service to play said incoming voice message. In yet another example, an intended event may be associated with a notification or message intended for all users in room 401, and operating system 404a may select one or more of a display service associated with display 410, an audio broadcast service associated with speaker 412, and a light display or vibration service associated with bands 404-0-404-3 as one or more preferred services for providing said public notification or message. For example, operating system 404a may select an LED light service associated with bands 404-0-404-3 as a preferred service for notifying all users in room 401 (e.g., in view of environmental data indicating loud ambient noise, large distances between users, or other data indicating a communal audio or visual display to be unsuitable for notification) of a start to a game or competition, and as a result, bands 404-0-404-3 light up at a time associated with said start to the game or competition. In other examples, the quantity, type, function, structure, and configuration of the elements shown may be varied and are not limited to the examples provided.

FIG. 5 illustrates an exemplary flow for rendering an intended event into a sensory output. Here, flow 500 begins with generating, by an application, event data associated with an intended event (502). In some examples, an intended event may be associated with an intention to perform an operation (e.g., provide an alarm, provide a notification, display a message, play a voice message, play a voice message, or the like). In some examples, generating an intended event may include receiving data associated with said intended event from another application or other remote or local source. For example, a calendar application on a mobile device may receive data associated with an intended event (e.g., a notification associated with an upcoming deadline or calendar event, an alarm associated with an upcoming meeting, or the like) from a remote database (e.g., accessible using a network, in the cloud, or the like). In another example, data associated with an intended event may be received by said calendar application from an email application providing an email including a calendar notice. In still other examples, different applications may be involved in generating data associated with an intended event. In some examples, said data associated with an intended event may be provided to an operating system, which may then determine one or more outputs associated with the intended event (504). In some examples, said one or more outputs may include a sensory output configured to provide a physical rendering of the intended event for a user to sense (e.g., hear, see, feel and the like). In other examples, an application may be configured to determine one or more outputs associated with said intended event, and also may be configured to provide data associated with the one or more outputs to an operating system.

In some examples, one or more available services on a device in data communication with the application may be discovered using an operating system comprising a service discovery module (506). In some examples, an operating system also may be configured to publish available services on a device in which said operating system is being implemented, for example, to a service discovery module. In other examples, a service discovery module implemented in an operating system may be configured to discover available services on other devices with which said operating system may be configured to exchange data, for example, using a short-range communication protocol (i.e., with nearby devices), as described herein. In some examples, a service discovery module may discover available services using one or more service discovery protocols (e.g., Bluetooth® Service Discovery Protocol (Bluetooth® SDP), WiFi DNS Service Discovery (WiFi DNS-SD), multicast DNS-SD, or the like). In some examples, a service discovery module may be configured to generally discover some or all available services on nearby devices. In other examples, a service discovery module may be configured to query nearby devices for a type of service. In still other examples, a service discovery module may be configured to query nearby devices for services matching a type of sensory output or a type of intended event (i.e., available services configured to provide outputs associated with a type of sensory output or Intended event), in some examples, an intended event may be associated with a plurality of outputs. For example, an incoming text message may be displayed on a screen, and it also may be translated, into an audible message. In another example, an alarm or other non-verbal, non-textual, non-graphic notification may be provided by a vibration, by a light, or by a sound or noise. In some examples, an operating system may fee configured to discover available services on one or more nearby devices. Once available services are discovered, an operating system may select a preferred service configured to provide an output associated with the intended event (508). In some examples, a preferred service may be selected based cm various factors associated with stored, or captured, historical or real-time, data, for example, from a sensor, a user interface, or a remote or local database. In some examples, such data may include, without limitation, environmental data (i.e., captured by one or more sensors), profile data associated with characteristics of a service (i.e., service profile data), user preference data, or the like (see, e.g. How 600 in FIG. 6). Once a preferred service is selected, data may be sent to the device, the data configured to cause the device to provide the output using the preferred service (510). In some examples, a preferred service may be selected from services available on a local device implemented with an operating system performing the selection. In other examples, a preferred service may be selected from services available on a nearby device. In some examples, a preferred service may be selected from services available on a plurality of devices, including local and nearby devices. For example, a preferred service may include an LED light function on a plurality of wearable bands being worn by a plurality of users in a room, a house, a building, a specified radius (i.e., as defined by a threshold proximity) or other area or environment. In another example, a preferred service may include a television or other display being watched by one or more users. In still another example, a preferred service may be an interface (e.g., screen, light, or the like) or application on a mobile device. In yet other examples, the above-described process may be varied in steps, order, function, processes, or other aspects, and is not limited to those shown and described.

FIG. 6 illustrates an exemplary flow for selecting a preferred service for providing an output. Here, flow 600 begins with cross-referencing one or more available services with one or more outputs associated with an intended event to match an available service with an output (602). In some examples, a service may be associated (i.e., matched) with more than one output. In some examples, an output may be associated (i.e., matched) with more than one service. In some examples, said one or more outputs may be previously identified as being appropriate for rendering said intended event into a sensory output. Then, a ranking may be assigned to each of the one or more available services using environmental data captured by one or more sensors (604). In some examples, said ranking may be adjusted or weighted in view of other data associated with selecting a preferred service, including service profile data describing characteristics of a service. In some examples, the one or more available services also may be cross-referenced with user profile data comprising one or more user preferences (606). In some examples, such user profile data also may be used to adjust or weight the ranking. In other examples, such user preference data may be considered differently in selecting a preferred service. In some examples, said user profile data may be obtained using a user interface. In some examples, said user profile data may be predetermined or preprogrammed and stored in a memory (e.g., memory 102 in FIG. 1, memory 706 in FIG. 7, or the like) or storage (e.g., storage 216 in FIG. 2, storage device 708 in FIG. 7, or the like). Then, a preferred service may be selected using the one or more outputs, the ranking and the user profile data (608). In some examples, a selection of a preferred service may be performed by an operating system, as described herein. In other examples, the above-described process may be varied in steps, order, function, processes, or other aspects, and is not limited to those shown and described.

FIG. 7 illustrates an exemplary computing platform disposed in or associated with a wireless device. In some examples, computing platform 700 may be used to implement computer programs, applications, methods, processes, algorithms, or other software to perform the above-described techniques. Computing platform 700 includes a bus 702 or other communication mechanism for communicating information, which interconnects subsystems and devices, such as processor 704, system memory 706 (e.g., RAM, etc), storage device 708 (e.g., ROM, etc.), a communication interface 713 (e.g., an Ethernet or wireless controller, a Bluetooth controller, etc.) to facilitate communications via a port on communication link 721 to communicate, for example, with a computing device, including mobile computing and/or communication devices with processors. Processor 704 can be implemented with one or more central processing units (“CPUs”), such as those manufactured by Intel® Corporation, or one or more virtual processors, as well as any combination of CPUs and virtual processors. Computing platform 700 exchanges data representing inputs and outputs via input-and-output devices 701, including, but not limited to, keyboards, mice, audio inputs (e.g., speech-to-text devices), user interfaces, displays, monitors, cursors, touch-sensitive displays, LCD or LED displays, speakers, media players and other I/O-related devices.

According to some examples, computing platform 700 performs specific operations by processor 704 executing one or more sequences of one or more instructions stored in system memory 706, and computing platform 700 can be implemented in a client-server arrangement, peer-to-peer arrangement, or as any mobile computing device, including smart phones and the like. Such instructions or data may be read into system memory 706 from another computer readable medium, such as storage device 708. In some examples, hard-wired circuitry may be used in place of or in combination with software instructions for implementation. Instructions may be embedded in software or firmware. The term “computer readable medium” refers to any non-transitory medium that participates in providing instructions to processor 704 for execution. Such a medium may take many forms, including but not limited to, non-volatile media and volatile media. Non-volatile media includes, for example, optical or magnetic disks and the like. Volatile media includes dynamic memory, such as system memory 706.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM. FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 702 for transmitting a computer data signal.

In some examples, execution of the sequences of instructions may be performed by computing platform 700. According to some examples, computing platform 700 can be coupled by communication link 721 (e.g., a wired network, such as LAN. PSTN, or any wireless network) to any other processor to perform the sequence of instructions in coordination with (or asynchronous to) one another. Computing platform 700 may transmit and receive messages, data, and instructions, including program code (e.g., application code) through communication link 721 and communication interface 713. Received program code may be executed by processor 704 as it is received, and/or stored in memory 706 or other non-volatile storage for later execution.

In the example shown, system memory 706 can include various modules that include executable instructions to implement functionalities described herein. In the example shown, system memory 706 includes operating system 710, which may be configured to publish and discover services, and to select a preferred service for rendering an intended event into a sensory output, as described herein. System memory 706 also may include application 712, which may be configured to generate data associated with an intended event, and to identify one or more outputs associated with an intended event, as described herein.

In some embodiments, wireless device 101 and output device 118 in FIG. 1, band 302, mobile device 304, display 306 and speaker 308 in FIG. 3, band 404-0-404-3, mobile device 406, headset 408, display 410 and speaker 412 in FIG. 4, can communicate (e.g., wired or wirelessly) with each other, or with other compatible devices. In some eases, the above-mentioned devices, or any networked computing device (not shown) in communication therewith, can provide at least some of the structures and/or functions of any of the features described herein. As depicted in FIGS. 1-4 herein, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in FIGS. 1-4 can represent one or more algorithms. Or, at least one of the elements can represent a portion of logic including a portion of hardware configured to provide constituent structures and/or functionalities.

As hardware and/or firmware, the structures and techniques described herein can be implemented using various types of programming or integrated circuit design languages, including hardware description languages, such as any register transfer language (“RTF”) configured to design field-programmable gate arrays (“FPGAs”), application-specific integrated circuits (“ASICs”), multi-chip modules, or any other type of integrated circuit. For example, wireless device 101, including one or more components, can be implemented, in one or more computing devices that include one or more circuits. Thus, at least one of the elements in FIGS. 1-4 can represent, one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

The foregoing description, for purposes of explanation, uses specific nomenclature to provide a thorough understanding of the invention. However, it will be apparent to one skilled in the art that specific details are not required in order to practice the invention. In fact, this description should not be read to limit any feature or aspect of the present invention to any embodiment; rather features and aspects of one embodiment can readily be interchanged with other embodiments. Notably, not every benefit described herein need be realized by each embodiment of the present invention; rather any specific embodiment can provide one or more of the advantages discussed above, in the claims, elements and/or operations do not imply any particular order of operation, unless explicitly stated in the claims. It is intended that the following claims and their equivalents define the scope of the invention. Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed is:

1. A method, comprising:
generating, by an application, an intended event;
discovering, using an operating system comprising a service discovery module, one or more available services on a device in data communication with the application; and
selecting, using the operating system, a preferred service configured to provide an output associated with the intended event.

2. The method of claim 1, further comprising determining, using the application, one or more outputs associated with the intended event.

3. The method of claim 1, wherein the output is configured to render the intended event to a physical manifestation able to be sensed by a user.

4. The method of claim 1, further comprising sending data to the device, the data configured to cause the device to provide the output using the service.

5. The method of claim 1, wherein selecting, using the operating system, a preferred service configured to provide the output comprises determining at least one of the one or more available services to be suitable to provide at least one of the one or more outputs.

6. The method of claim 1, wherein selecting, using the operating system, a preferred service configured to provide the output comprises cross-referencing the one or more available services with the one or more outputs.

7. The method of claim 1, wherein selecting, using the operating system, a preferred service configured to provide the output comprises assigning a ranking to each of the one or more available services using environmental data captured by one or more sensors.

8. The method of claim 1, wherein selecting, using the operating system, a preferred service configured to provide the output comprises cross-referencing the one or more available services with user profile data comprising one or more user preferences.

9. The method of claim 8, further comprising adjusting a ranking assigned to each of the one or more available services using the user profile data.

10. The method of claim 1, further comprising publishing the one or more available services to a service discovery module.

11. The method of claim 9, wherein the service discovery module is implemented on a local device.

12. The method of claim 9, wherein the service discovery module is implemented on the device, the device being in data communication with the operating system.

13. A system, comprising:
an application configured to generate an intended event;
an operating system configured to discover one or more available services on a device in data communication with the application, and to select a preferred service configured to provide an output associated with the intended event; and
a storage configured to store data associated with the one or more available services, the operating system being configured to use the data to select the preferred service.

14. The system, of claim 13, wherein the operating system comprises a service discovery module configured to implement one or more service discovery protocols.

15. The system of claim 13, further comprising a user interface configured to provide user preference data.

16. The system of claim 13, wherein the storage is configured to store service profile data representing characteristics associated with a service.

17. The system of claim 13, wherein the storage is configured to store service environment data.

18. The system of claim 13, wherein the storage is configured to store sensor data captured by one or more sensors.

19. The system of claim 13, wherein the operating system comprises a service selection module configured to select the preferred service using one or more of service profile data, service environment data, sensor data, and user preference data.

20. A computer program product embodied in a computer readable medium and comprising computer instructions for;
generating, by an application, an intended event;
discovering, using an operating system composing a service discovery module, one or more available services on a device in data communication with the application; and
selecting, using, the operating system, a preferred service configured to provide an output associated with the intended event
